(19) United States
(12) Patent Application Publication
(10) Pub. No.: US 2007/0192800 A1
(43) Pub. Date: Aug. 16, 2007

(54) Dynamic multimedia channel grouping

(75) Inventors: Edward Walter, Boerne, TX (US); Yolius Diroo, San Antonio, TX (US); Steven M. Wollmershauser, San Antonio, TX (US); Ross Cox, Cumming, TX (US); Anthony A. Haeuser, Aurora, IL (US); Mary McCarthy, San Antonio, TX (US); Scott Pettit, San Antonio, TX (US); Christopher Lee, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/352,010

(22) Filed: Feb. 10, 2006

(51) Int. Cl. H04N 5/445; G06F 13/00; G06F 3/00; H04N 7/16

(52) U.S. Cl. 725/53; 725/135; 725/52

(57) ABSTRACT

A method includes determining a content type of a multimedia program at a first time for each of a plurality of multimedia channels and associating, during a first channel navigation period, each multimedia channel of a first subset of the plurality of multimedia channels with a corresponding channel number of a channel numbering sequence. The method additionally includes determining a content type of a multimedia program at a second time for each of the plurality of multimedia channels and associating, during a second channel navigation period, each multimedia channel of a second subset of the plurality of multimedia channels with a corresponding channel number of the channel numbering sequence. Each multimedia program of the first subset includes a first content type at the first time and each multimedia program of the second subset includes the first content type at the second time.

### FIELD OF THE DISCLOSURE

The present disclosure is generally related to the selection and display of multimedia content and the grouping of channel identifiers related thereto.

### BACKGROUND

Multimedia content providers, such as broadcasters, cable television providers, and satellite television providers, conventionally assign multimedia channels to corresponding channel numbers so that the correspondence between a particular channel number and a multimedia channel is static. However, with the increasingly large number of channels offered, this static channel number assignment typically requires a user to unnecessarily expend time navigating among the numerous channels while attempting to find and view channels having content of interest to the viewer. Accordingly, an improved technique for arranging channels with corresponding channel numbers would be advantageous.

### BRIEF DESCRIPTION OF THE DRAWINGS

FIG. 1 is a diagram illustrating an exemplary technique for dynamically assigning channels to corresponding channel numbers based on content during a navigation period in accordance with one embodiment of the present disclosure.

FIG. 2 is a diagram illustrating an exemplary user interface for configuring a dynamic channel numbering in accordance with at least one embodiment of the present disclosure.

FIGS. 3 and 4 are block diagrams illustrating exemplary systems implementing dynamic channel number sequences in accordance with at least one embodiment of the present disclosure.

FIGS. 5 and 6 are flow diagrams illustrating exemplary dynamic channel numbering methods in accordance with at least one embodiment of the present disclosure.

FIG. 7 is a block diagram illustrating an exemplary computer system in accordance with at least one embodiment of the present disclosure.

### DETAILED DESCRIPTION OF THE DRAWINGS

In accordance with a particular aspect of the present disclosure, a method includes determining a content type of a multimedia program at a first time for each of a plurality of multimedia channels. The method further includes associating, during a first channel navigation period, each multimedia channel of a first subset of the plurality of multimedia channels with a corresponding channel number of a first channel numbering sequence. In one embodiment, each multimedia program of the first subset includes a first content type at the first time. The method additionally includes determining a content type of a multimedia program at a second time for each of the plurality of multimedia channels and associating, during a second channel navigation period, each multimedia channel of a second subset of the plurality of multimedia channels with a corresponding channel number of the first channel numbering sequence. In one embodiment, each multimedia program of the second subset includes the first content type at the second time.

In accordance with another aspect of the present disclosure, the method includes associating a first multimedia channel with a first channel number during a first channel navigation period in response to a content of the first multimedia channel at a first time including a first content type. The method further includes associating the first multimedia channel with a second channel number that is different than the first channel number during a second channel navigation period that is subsequent to the first channel navigation period. The first multimedia channel is associated with the second channel number in response to the content of the first multimedia channel at a second time including a second content type that is different than the first content type.

In accordance with an additional aspect of the present disclosure, a computer readable medium embodies a computer program. The computer program includes instructions to generate data representative of an electronic programming guide. The electronic programming guide includes a first channel number sequence associated with a first set of multimedia channels having a first content type at a selected time and a second channel number sequence, different than the first number sequence, associated with a second set of multimedia channels having a second content type at the selected time. The computer program further includes instructions to provide a representation of the electronic programming guide for display.

In accordance with another aspect of the present disclosure, a multimedia system includes an electronic programming guide module to generate an electronic programming guide having a first channel number sequence and a second channel number sequence. The first channel number sequence is associated with a first set of multimedia channels having a first content type at a selected time and the second channel number sequence is associated with a second set of multimedia channels having a second content type at the selected time.

For ease of illustration, the exemplary techniques disclosed herein are described in the context of a set-top box, such as a cable television set-top box, a satellite television set-top box, or a personal video recorder (PVR). Using the guidelines provided herein, those skilled in the art can utilize the disclosed techniques in other multimedia processing devices without departing from the scope of the present disclosure. Examples of other multimedia processing devices in which the disclosed techniques may be advantageously employed include televisions, portable video players, personal digital assistants (PDAs), desktop computers, notebook computers, video-enabled cell phones, and the like.

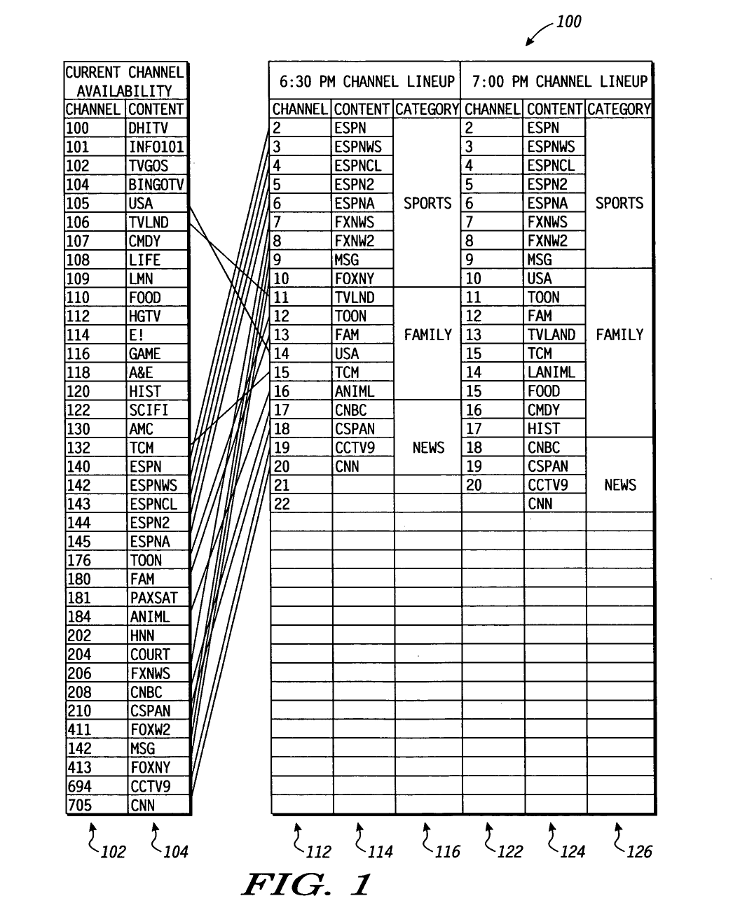

Referring to FIG. 1, an exemplary dynamic channel grouping scheme 100 is illustrated in accordance with at least one embodiment of the present disclosure. Conventionally, the set of multimedia channels provided by a multimedia content provider, such as a cable television provider, is fixedly associated with a corresponding sequence of channel numbers. To illustrate, column 102 of scheme 100 illustrates a sequence of channel numbers associated with a set of multimedia channels of column 104, where each channel number of column 102 is fixedly associated with one of the multimedia channels of column 104. In many conventional systems, the channel numbering is implemented so that sequential groups of multimedia channels are permanently associated with multimedia channels known to have the same type of content. To illustrate, because the channels FXNWS, CNBC, and CSPAN are expected to provide mainly news content, a content provider may permanently associate these channels with channel numbers 205, 208 and 210, respectively.

However, in many instances, the content provided by a particular multimedia channel changes over the course of a day. To illustrate, certain channels may provide news programs during the morning and early-evening periods, soap operas and other drama programs during the mid-day period, and comedy programs during the late-evening period. Thus, the fixed channel numbering scheme typically provides an inefficient browsing environment for a viewer who desires to sequentially browse among programs having similar content at the time that the viewer is navigating among the channels. Accordingly, in at least one embodiment, the scheme 100 frequently adjusts the channel numbering of the set of multimedia channels so that channels having similar program content during a navigation period associated with the adjustment stimulus are grouped together by channel number. The navigation period represents a relatively short predetermined time period for which the channel numbering scheme is to remain constant. Thus, because programs typically are not shorter than approximately thirty minutes, the navigation periods can include, for example, successive thirty minute periods (e.g., from 6:30 PM-7:00 PM and from 7:00 PM-7:30 PM). Other exemplary navigation periods can include, but are not limited to, fifteen minute periods, one hour periods, two hour periods, twenty-four hour periods, and any combination thereof.

To illustrate, for a navigation period from 6:30 PM-7:00 PM (represented by columns 112, 114 and 116), the channels ESPN, ESNWS, ESPNCL, ESPN2, ESPNA, FXNWS, FOXW2, MSG, and FOXNY carry sports-related programs and therefore can be associated with, for example, a channel numbering sequence including channel numbers 2-10, respectively. Likewise, in this example channels TVLAND, TOON, FAM, USA, TCM, and ANIML carry family-related programs during the 6:30 PM-7:00 PM navigation period and therefore can be associated with a channel numbering sequence including channels 11-16, respectively. Further, channels CNBC, CSPAN, CCTV9, and CNN carry news-related programs during the 6:30 PM-7:00 PM navigation period and therefore can be associated with a channel numbering sequence including channels 17-20, respectively.

During the subsequent navigation period from 7:00-7:30 PM (represented by columns 122, 124, and 126), the channels ESPN, ESNWS, ESPNCL, ESPN2, ESPNA, FXNWS, FOXW2, and MSG carry sports-related programs in this example and therefore can be associated with a channel numbering sequence including channel numbers 2-9, respectively. Also during this navigation period, channels USA, TOON, FAM, TVLAND, TCM, ANIML, FOOD, CMDY, and HIST carry family-related programs in this example and therefore can be associated with a channel numbering sequence including channel numbers 10-17, respectively. Additionally, channels CNBC, CSPAN, CCTV9, and CNN carry news-related programs during the 7:00 PM-7:30 PM navigation period and therefore can be associated with a channel numbering sequence including channel numbers 18-20, respectively.

When a user directs a multimedia processing device implementing the exemplary scheme 100 to perform a channel navigation action, such as a next channel/channel up action, a previous channel/channel down action, the selection of a particular channel number, and the like, the particular channel provided by the multimedia processing device in response is based on the particular navigation period. To illustrate, if a viewer were to select channel number 11 (either by explicitly selecting channel 11 or by navigating down from channel 12 or up from channel 10) at 6:49 PM, the multimedia processing device would provide the channel FOXNY for display because the scheme 100 provides that the channel FOXNY is associated with channel 11 between 6:30 and 7:00 PM. Conversely, if a viewer were to select channel number 11 at 7:15 PM, the multimedia processing device would provide the channel TOON because the scheme 100 provides that the channel TOON is associated with channel 11 between 7:00 PM and 7:30 PM.

As the dynamic channel numbering scheme 100 illustrates, the numbering of channels may be changed frequently to more-closely tailor the numbering of channels to a viewer's navigation preferences. For example, a sports-oriented viewer can configure the scheme 100 such that channels carrying sports-related programs during a particular navigation period are at the lowest channel numbers so that the viewer can quickly browse through them. However, another viewer may prefer family-oriented programs and therefore may configure the scheme 100 such that family related programs are associated with the lowest channel numbers.

Additionally, in at least one embodiment, a viewer can configure the scheme 100 so that the channel numbering sequences associated with various categories are rearranged between navigation periods. To illustrate, a family may utilize the multimedia processing device such that the adults view news-related programs in the morning, the children view family-related programs during the afternoon, and the entire family views news programs and situational comedy (sitcom) programs during the evenings. Accordingly, in this instance the lowest-numbered channel sequence may be associated with channels carrying news-related content from 6:00 AM to 12:00 PM, with channels carrying family-related content from 12:00 PM to 6:00 PM, and with channels carrying news-related programs and sitcom-related programs from 6:00 PM to 6:00 AM. In this manner, the programs most likely to be viewed for any given time period are located at the lowest numbered channels for ease of navigation.

In addition to dynamically changing the channel numbering of channels based on their changing content, various characteristics of the channel numbering sequences can change between navigation periods. To illustrate, the channel numbering sequence associated with a particular content category can be set to a fixed number of channels or even a fixed channel numbering. Alternately, the number of channels in a channel numbering sequence associated with a particular content category may change between navigation periods based on viewer preferences or may change due to the changing number of channels carrying programs with the particular content category. Moreover, the content categories may be combined and the combination may be associated with a particular channel numbering sequence. To illustrate, the lowest-numbered channel numbering sequence can be associated with channels having news content for morning navigation periods and can be associated with channels having either news content or action content for evening navigation periods.

In a number of set-top box implementations, a viewer can provide a search parameter (such as, for example, the first letter of a program name) to identify programs matching the provided search parameter. Accordingly, in at least one embodiment, channel numbering sequences can be associated with the results of program searches performed by a viewer. For example, a viewer may provide a search for all programs having comedy content and which also feature the comedian “John Comedy.” The viewer may configure the scheme 100 so that the first channel numbers are associated with any channels carrying programs that meet the search during the evening navigation periods.

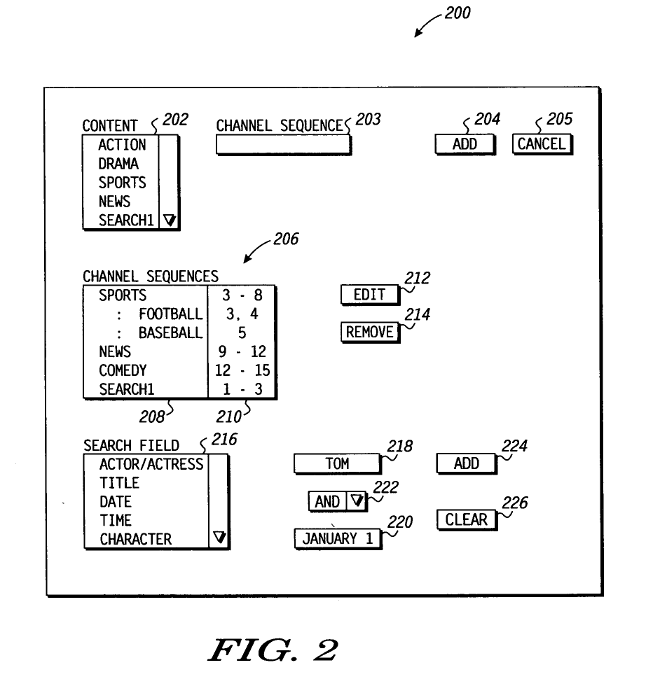

Referring to FIG. 2, an exemplary dynamic channel numbering configuration graphical user interface (GUI) 200 is illustrated in accordance with at least one embodiment of the present disclosure. The GUI 200, in one embodiment, is implemented by a multimedia processing device and provided for interaction by a viewer so as to obtain dynamic channel numbering configuration from the viewer for use in implementing a dynamic channel numbering scheme. The GUI 200 can be implemented as, for example, part of an electronic programming guide (EPG) provided via a set-top box.

In the depicted example, the GUI 200 includes a content field 202, a channel sequence field 203, an add button 204, and a cancel button 205 for use by a viewer to associate a particular channel numbering sequence with one or more selected content categories. To illustrate, after selecting one or more content categories (e.g., action, drama, sports, news, search results, etc.) or content sub-categories (e.g., sports:football, sports:soccer, etc.) from the content field 202, the viewer can provide a channel numbering sequence (e.g., channel numbers 2-10) to associate with the selected content category or categories. Alternately, in the event that the viewer desires to implement flexible channel numbering, the viewer may provide a maximum number of channel numbers to be associated with the selected content category or categories (e.g., “max 10”) or to provide a ranking of the channel numbering sequence that is to be associated with the selected content category or categories (e.g., “rank 2”), where the ranking determines what position the channel numbering sequence occurs with respect to other channel numbering sequences associated with other content categories.

The GUI 200 further may include a channel numbering sequences display 206 that provides a list (column 208) of entered channel numbering sequences and their corresponding preferred channel numbering characteristics (column 210). The ordering, numbering and categorization of the entered channel numbering sequences can be edited in response to a selection of an edit button 212 or removed in response to a selection of a remove button 214.

The GUI 200 further may include a search field 216, search parameter fields 218 and 220, search operand field 222, add button 224, and clear button 226 for use by a viewer in creating a program search query for implementation within the dynamic channel numbering scheme. The search field 216 can include any of a variety of search parameters associated with multimedia programs including, but not limited to, an actor/actress parameter, a title parameter, a date parameter, a time parameter, a character parameter, and the like. The search parameter fields 218 and 220 may be used to enter particular values for a selected search parameter (e.g., a value of “Tom” for the actor/actress parameter and a value of “January 1” for the date parameter). The operand field 222 may be used to select a logical correspondence between the provided parameter values, such as AND, OR, XOR logical correspondences. Upon selection of the add button 224, the input search query is named and added to the content field 202, whereupon the viewer can select the search query and provide configuration for the search parameter, such as a particular channel numbering sequence or ranking for any resulting programs identified by the search query.

As discussed above, the channel numbering sequences associated with various content categories may change between navigation periods. To illustrate, the relative positions of the channel numbering sequences may change, the number of channels in the channel numbering sequences may change, new channel numbering sequences may be added and other channel numbering sequences may be removed. In such instances, the GUI 200 further may include configuration fields (not shown) that may be used to further configure the channel numbering sequences in view of user preferences.

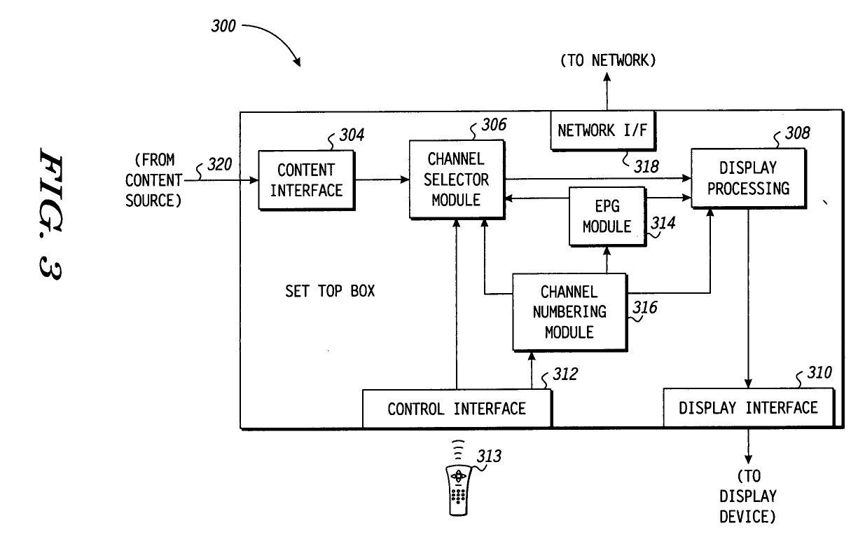

Referring to FIG. 3, an exemplary multimedia processing device implementing dynamic channel numbering is illustrated in accordance with at least one embodiment of the present disclosure. For ease of illustration, the device is described in the context of a set-top box 300 used to provide television content for display. However, those skilled in the art may implement the device of FIG. 3 in other multimedia processing devices, such as multimedia-enabled personal computers, cellular phones, personal digital assistants, and the like, without departing from the scope of the present disclosure.

In the depicted example, the set-top box 300 includes a content interface 304, a channel selector module 306, a display processing module 308, a display interface 310, a control interface 312, an electronic programming guide (EPG) module 314, a channel numbering module 316, and a network interface 318. The components of the set-top box 300 may be implemented as hardware, software, firmware, or any combination thereof. To illustrate, one or more of the components may be implemented as logic operable to perform the corresponding functions or as software stored in a memory and executed by one or more processors so as to manipulate the processor(s) to perform the corresponding functions.

In operation, multimedia content data 320 representative of a plurality of multimedia channels is received from one or more content providers (e.g., a cable television provider) and preprocessed by the content interface 304. The channel selector module 306 selects a particular channel for display based on user input received via the control interface 312 and based on channel numbering information provided via the channel numbering module 316. The selected channel then is provided to the display processing module 308 for processing for display, where the display processing can include decryption, decoding, filtering, digital-to-analog conversion, and the like. The resulting display data is provided to the display interface 310 for output to a display device, such as a television or monitor connected to the set top box 300.

In at least one embodiment, the channel selected by the channel selector module 306 corresponds to a channel selection input received at the control interface 312 via, for example, a remote control 313 or a button panel (not shown). The channel selection input can include, for example, a next channel/channel up input, a previous channel/channel down input, or input indicating a particular channel number. The channel selector module 306 determines the channel number identified by the channel selection input and then queries the channel numbering module 316 for the channel currently associated with the identified channel numbering.

The channel numbering module 316, in at least one embodiment, implements at least a portion of the dynamic channel numbering techniques described herein. In this respect, the channel numbering module 316 dynamically assigns channels to corresponding channel numbering sequences for one or more navigation periods based on viewer preferences (obtained, for example, via the GUI 200 of FIG. 2 provided by the EPG module 314). Accordingly, content information for the plurality of channels for the navigation periods can be provided as EPG information by the EPG module 314, where the EPG module 314 may obtain the EPG information from the content source or from a networked source via, for example, the network interface 318. Based on the content information, the channel numbering module 316 identifies the content of some or all of the channels for a navigation period and then applies the dynamic channel numbering configuration so as to assign a particular channel number to each of the channels, where the channel number assignment is applicable for the associated navigation period as described above with reference to FIG. 1. Upon receipt of the identified channel number from the channel selector module 306, the channel numbering module 316 determines the corresponding channel based on the channel numbering scheme implemented for the current navigation period and then returns a channel identifier (e.g., an index number or a channel name) to the channel selector module 306. The channel selector module 306, in response, selects the channel corresponding to the supplied channel identifier for processing for display.

In one embodiment, the channel numbering module 316 configures the channel numbering scheme for a sequence of navigation periods ahead of time. To illustrate, the channel numbering module 316 may obtain content information from the EPG module 314 for a two-hour time period and then configure the channel numbering scheme for each of the four thirty-minute navigation periods that constitute the two-hour time period at the same time. In another embodiment, the channel numbering module 316 configures the channel numbering scheme at the start of each navigation period. In yet another embodiment, the channel numbering module 316 reconfigures the channel numbering scheme in response to certain navigation inputs from a viewer. To illustrate, a viewer may direct the set-top box 300 to provide an EPG for display using, for example, an EPG button of the remote 313. In response to the request to view the EPG, the channel numbering module 316 may obtain the content information from the EPG module 314, determine the channel numbering scheme using the content information and channel numbering configuration information for the navigation period, and then provide the resulting channel numbering scheme to the EPG module 314. The EPG module 314 then may configure its displayed EPG to reflect the particular channel numbering implemented for the navigation period in which the set-top box 300 is operating.

In at least one embodiment, the set-top box 300 may service multiple viewers, where each viewer has provided customized channel numbering configuration information. Accordingly, in at least one embodiment, a viewer provides identification information via the control interface 312. In response to receiving the identification information, the channel numbering module 316 selects the identified viewer's channel numbering configuration and implements it to provide a dynamic channel numbering scheme adapted to the viewer's preferences. Additionally, a residence or other location may have multiple set-top boxes and displays. Rather than having to configure each set-top box 300 at the location, in one embodiment, a single set-top box may be configured for one or more viewer's and these configurations then may be provided to the other set-top boxes for implementation via, for example, a wireless interface (one embodiment of the network interface 318).

The EPG provided for display by the EPG module 314, in one embodiment, can be configured to reflect the dynamic channel numbering scheme determined by the channel numbering module 316, as well as providing search results from search queries input by a viewer. Further, in at least one embodiment, the EPG module 314 may provide an EPG that implements a menu hierarchy that allows a viewer to quickly browse through available offerings. An exemplary menu hierarchy can include:

Live TV
Guide
Favorites
Search
   (searches both Live TV and On Demand content)

Recorded TV
Browse recordings
Scheduled
Set recording

Video On Demand
Video Store
   Featured
      Spotlight (New Releases, Sponsored endorsements, etc.)
      Special Offers (Programming and Promotions from SBC)
      Last Chance! (Last Chance to see Movies before they disappear)
   Movies
      All Movies
      New Releases
      HD Movies
      By Genre
         Comedy
         Drama
         Kids/Family
         Action/Adventure
         Sci-Fi/Horror
         Music
         Independent
         Documentary
      Independent
      Adult
      En Espanol
      Coming Soon (movie trailers; coming soon to U-Verse)
         To Theaters
         Now on U-Verse VOD
      Cinema Exposed
   Shows
      All Shows
      New Releases
      HD Shows
      By Genre
         Comedy
         Drama
         Kids/Family
         Action/Adventure
         Sci-Fi/Horror
         Classic TV
         News
         Sports
         Reality
         Music
         Documentary
      On the Edge (Internet/Animation/Festival content)
      Lifestyles (Technology/Hobby/Home Improvement/ Gambling/How-To's)
      Adult
   Pay Per View events
      (listed individually by event name)
      Uncensored (special events without ratings—adult related)
Current Rentals
   (displays movies or shows that have been purchased, and additional viewings are available)
Free On Demand
   MagRack
   HBO On Demand
   Showtime On Demand
   Cinemax On Demand
Subscription On Demand
   Disney Magic Kingdom Pass
      Animated Movies
         101 Dalmatians
         Alice in Wonderland
         Bambi
         Beauty and the Beast
         Cinderella
         Fantasia
         The Incredibles
         Peter Pan
         Pocahontas
         Pinocchio
         Sleeping Beauty
         Toy Story
      Live Action
      Preschool
      Memory Lane
   Anime Network
   Viacom Monthly Pass
   WWE On Demand
   20th Century Fox Monthly Pass
   Star Trek Monthly Pass
   The Best of Cooking with Emril
Search Video Store
   (searches On Demand content only)

Interactive
Games
   Free games
      Yahoo! games
   Current rentals
   Subscription games
   Pay-Per-Play games
Channels
   Yahoo! Channel
   HBO Interactive
   Showtime Interactive
   ESPN 360
Photos
U-Verse TV Today

Options
General
   Parental locking
   System sounds
   On screen language
   System Information
Television
   Customize channels
   Favorite channels
   Guide style
   Aspect ratio
   On-screen display size
Account
   View my bill
   View my services
Restart

Help
Help On Demand (tunes to channel 100)
Help Channel (tunes to channel 99)

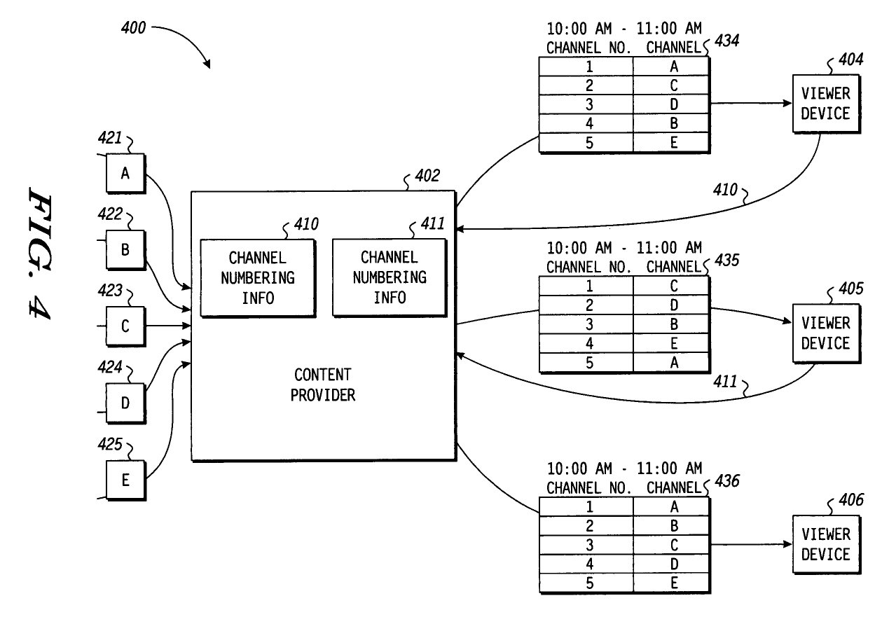

Referring to FIG. 4, an exemplary multimedia content distribution system 400 implementing dynamic channel numbering is illustrated in accordance with at least one embodiment of the present disclosure. In addition to, or rather than, implementing the dynamic channel numbering scheme at the viewer's end, dynamic channel numbering between navigation periods can be implemented at the content provider or at an intermediary as illustrated. Thus, as depicted, the system 400 includes a multimedia content provider 402 connected to a plurality of multimedia processing devices (viewer devices 404, 405 and 406) via a distribution network (e.g., a cable network, a packet-based data network, a wireless network, or any combination thereof).

In the illustrated example, the content provider 402 is configured to provide dynamic channel numbering schemes to viewer devices 404 and 405 and to provide a conventional fixed channel numbering scheme to viewer device 406. Accordingly, the viewers associated with viewer devices 404 and 405 input their channel numbering configuration preferences at the devices 404 and 405, which provide this input to the content provider 402 as channel numbering information 410 and 411, respectively, for storage at the content provider 402.

The content provider 402, in the depicted example, receives multimedia channels 421-425 (also identified as channels A-E, respectively) for distribution. As the content provider is to provide fixed channel numbering to the viewer device 406, the channels are provided to the viewer device 406 according to a conventional fixed numbering scheme 436 where channels A-E are fixedly associated with channel numbers 1-5, respectively. In contrast, because the content provider 402 is configured to provide dynamic channel numbering to viewer devices 404 and 405, the content provider 402 accesses the stored channel numbering information 410 and 411 and dynamically arranges the numbering of the channels for one or more navigation periods in accordance with the viewer's supplied preferences. Accordingly, the content provider 402 provides dynamic channel numbering schemes 434 and 435 to the viewer devices 404 and 405, respectively. In this example, scheme 434 has channel numbers 1-5 associated with channels A, C, D, B, and E, respectively, and scheme 435 has channel numbers 1-5 associated with channels C, D, B, E, and A. The viewer devices 404 and 405 implement the provided schemes 434 and 435 for viewer navigation during the corresponding navigation period(s).

In one embodiment, the content provider 402 provides the schemes 434 and 435 to the viewer devices 404 and 405 by actually rearranging the channels in numbering sequence. To illustrate, in analog television transmissions, each channel number is associated with a particular frequency band, so the content provider may rearrange the channels within the frequency bands to correspond to the desired numbering. In digital transmissions, multimedia data typically has header information identifying a channel number. In this instance, the content provider 402 may adjust the header information so that the corresponding channels are identified with the desired channel number. In another embodiment, the content provider 402 provides the multimedia channels A-E in the same arrangement to both viewer devices 404 and 405, but provides different sideband information, such as different channel/channel number tables, that is used by the viewer devices 404 and 405 to implement the schemes 434 and 435, respectively.

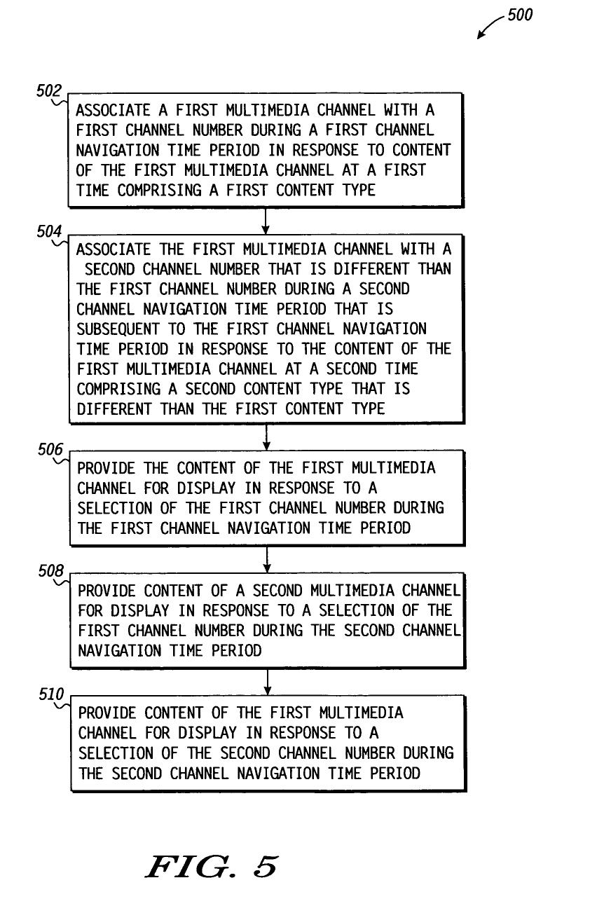

Referring to FIG. 5, an exemplary method 500 for dynamic channel numbering is illustrated in accordance with at least one embodiment of the present disclosure. The method 500 includes associating a first multimedia channel with a first channel number during a first channel navigation period in response to a content of the first multimedia channel at a first time comprising a first content type at block 502. In at least one embodiment, the first channel navigation period includes the first time. At block 504, the method includes associating the first multimedia channel with a second channel number that is different than the first channel number during a second channel navigation period that is subsequent to the first channel navigation period in response to the content of the first multimedia channel at a second time comprising a second content type that is different than the first content type. In at least one embodiment, the second channel navigation period includes the second time.

The method 500 further includes providing the content of the first multimedia channel for display in response to a selection of the first channel number during the first channel navigation period at block 506. At block 508, the method 500 includes providing the content of a second multimedia channel for display in response to a selection of the first channel number during the second channel navigation period. In one embodiment, the second multimedia channel is associated with the first channel number during the second channel navigation period. The method 500 additionally includes providing the content of the first multimedia channel for display in response to a selection of the second channel number during the second channel navigation period at block 510. The selection of the first channel number during the first and second channel navigation periods can include, for example, the selection of a next channel/channel up action, a previous channeuchannel down action, the selection of a particular channel number, and the like. The selection action may be made using, for example, a remote control or a button panel of a multimedia processing device.

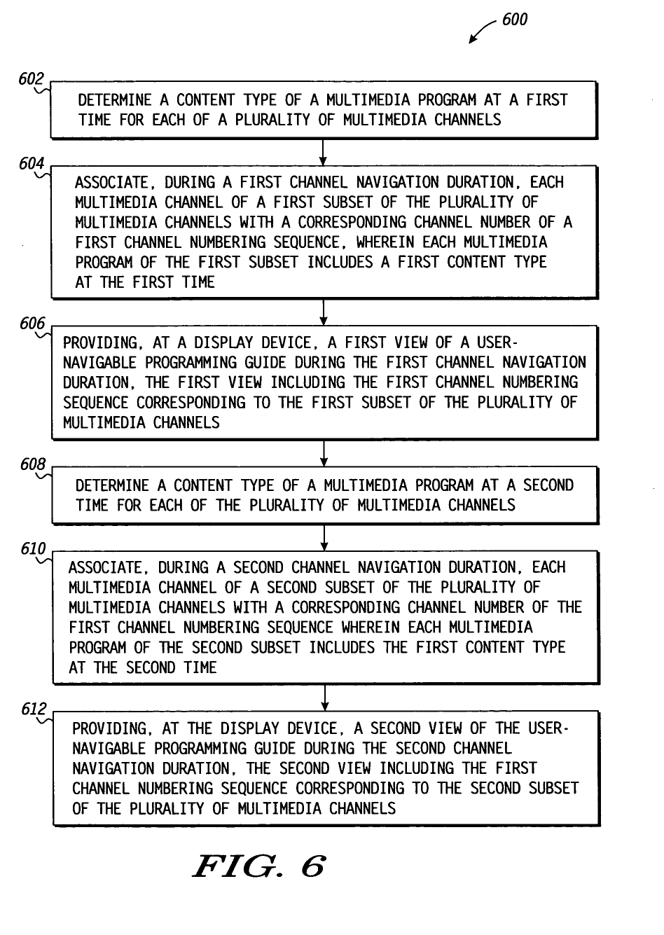

Referring to FIG. 6, an exemplary method 600 for dynamically associating channels with particular channel numbers based on content type is illustrated in accordance with at least one embodiment of the present disclosure. The method 600 includes determining a content type of a multimedia program at a first time for each of a plurality of multimedia channels at block 602. At block 604, the method 600 includes associating, during a first channel navigation period, each multimedia channel of a first subset of the plurality of multimedia channels with a corresponding channel number of a first channel numbering sequence. In one embodiment, each multimedia program of the first subset includes a first content type at the first time. The content type of each multimedia channel can be determined based on, for example, electronic programming guide information. The first subset can include a fixed number or variable number of channel numbers. At block 606, the method 600 includes providing, at a display device, a first view of a user-navigable programming guide during the first channel navigation period, the first view including the first channel numbering sequence corresponding to the first subset of the plurality of multimedia channels.

The method 600 further includes determining a content type of a multimedia program at a second time for each of the plurality of multimedia channels at block 608. In one embodiment, the first time is associated with a first display of an electronic programming guide and the second time is associated with a second display of the electronic programming guide. At block 610, the method 600 includes associating, during a second channel navigation period, each multimedia channel of a second subset of the plurality of multimedia channels with a corresponding channel number of the first channel numbering sequence. In one embodiment, each multimedia program of the second subset includes the first content type at the second time. The method 600 further includes providing, at the display device, a second view of the user-navigable programming guide during the second channel navigation period. The second view includes the first channel numbering sequence corresponding to the second subset of the plurality of multimedia channels.

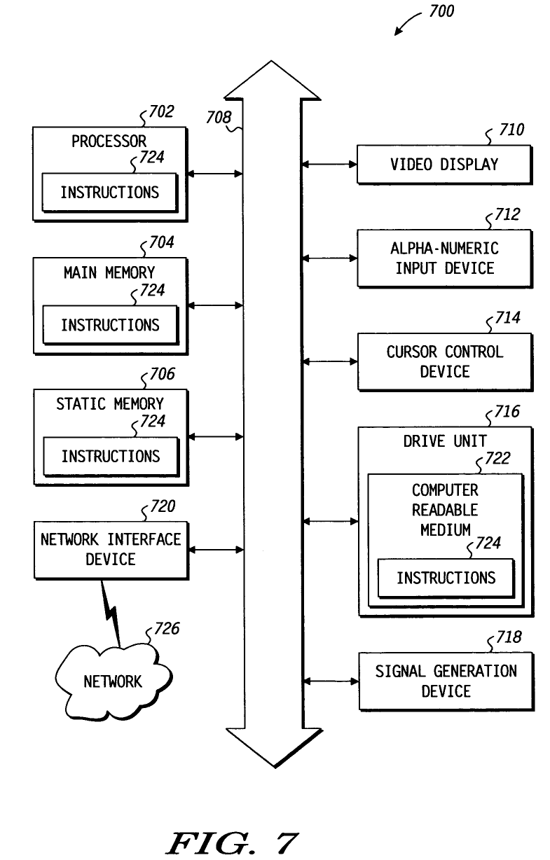

Referring to FIG. 7, an illustrative embodiment of a computer system is shown and is designated 700. The computer system 700 can include a set of instructions that can be executed to cause the computer system 700 to perform any one or more of the methods or computer-based functions disclosed herein. The computer system 700 may operate as a standalone device or may be connected, e.g., using a network, to other computer systems or peripheral devices.

The computer system 700 can be implemented as or incorporated into various devices, such as a set-top box, an Internet Protocol television (IPTV) device, a personal computer (PC), a tablet PC, a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system 700 can be implemented using electronic devices that provide multimedia data communication or processing. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a general processing unit (GPU), or both. Moreover, the computer system 700 can include a main memory 704 and a static memory 706 that communicate via a bus 708. As shown, the computer system 700 may further include or be connected to a video display unit 710, such as a liquid crystal display (LCD), an organic light emitting diode (OLED), a flat panel display, a solid state display, or a cathode ray tube (CRT). To illustrate, the computer system 700 may include a set-top box connected to a separate television display, whereby the set-top box receives and processed multimedia data in accordance with the disclosed techniques and provides the processed multimedia for display at the television device. Additionally, the computer system 700 may include an input device 712, such as a button pad, and a user input device 714, such as a remote control input or a video game control. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the techniques as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defming separately claimed subject matter.

The above disclosed subject matter is to be considered illustrative, and not restrictive, and the appended claims are intended to cover all such modifications, enhancements, and other embodiments that fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining a content type of a multimedia program at a first time for each of a plurality of multimedia channels;
associating, during a first channel navigation period, each multimedia channel of a first subset of the plurality of multimedia channels with a corresponding channel number of a first channel numbering sequence, wherein each multimedia program associated with the first subset has a first content type at the first time;
determining a content type of a multimedia program at a second time for each of the plurality of multimedia channels; and
associating, during a second channel navigation period, each multimedia channel of a second subset of the plurality of multimedia channels with a corresponding channel number of the first channel numbering sequence, wherein each multimedia program associated with the second subset has the first content type at the second time.

2. The method of claim 1, further comprising:
associating, during the first channel navigation period, each multimedia channel of a third subset of the plurality of multimedia channels with a corresponding channel number of a second channel numbering sequence, wherein each multimedia program of the third subset has a second content type at the first time.

3. The method of claim 2, further comprising:
associating, during the second channel navigation period, each multimedia channel of a fourth subset of the plurality of multimedia channels with a corresponding channel number of the second channel numbering sequence, wherein each multimedia program of the second subset has the second content type at the second time.

4. The method of claim 1, further comprising:
providing, at a display device, a first view of a user-navigable programming guide during the first channel navigation period, the first view including the first channel numbering sequence corresponding to the first subset of the plurality of multimedia channels; and
providing, at the display device, a second view of the user-navigable programming guide during the second channel navigation period, the second view including the first channel numbering sequence corresponding to the second subset of the plurality of multimedia channels.

5. The method of claim 4, further comprising:
receiving, during the first channel navigation period, a first user input indicating a selection of a first channel number of the first channel numbering sequence;
determining a first multimedia channel of the first subset corresponding to the first channel number; and
providing multimedia content of the first multimedia channel for display in response to receiving the first user input.

6. The method of claim 5, further comprising:
receiving, during the second channel navigation period, a second user input indicating a selection of the first channel number;
determining a second multimedia channel of the second subset corresponding to the first channel number; and
providing multimedia content of the second multimedia channel for display in response to receiving the second user input.

7. The method of claim 5, further comprising:
receiving, during the first channel navigation period, a second user input indicating a selection of a second channel number of the first channel numbering sequence;
determining a second multimedia channel of the first subset corresponding to the second channel number; and
providing multimedia content of the second multimedia channel for display in response to receiving the second user input.

8. The method of claim 1, wherein the first time is associated with a first display of an electronic programming guide and the second time is associated with a second display of the electronic programming guide.

9. The method of claim 8, wherein:
the electronic programming guide has a multilevel menu hierarchy comprising at least a first level, a second level and a third level; and
the first level includes at least one of a live television category, a recorded television category, a video on demand category, a current rentals category, and an interactive category; an options category and a help category.

10. The method of claim 1, wherein the content type of each multimedia channel is determined based on electronic programming guide information.

11. The method of claim 1, wherein the first subset comprises a fixed number of channel numbers.

12. The method of claim 1, wherein the first subset comprises a variable number of channel numbers.

13. The method of claim 1, further comprising:
receiving user input indicating a search parameter; and
associating, during the first channel navigation period, each multimedia channel of a third subset of the plurality of multimedia channels with a corresponding channel number of a third channel number sequence, wherein a multimedia program at the fist time of each multimedia channel of the third subset includes a characteristic consistent with the search parameter.

14. A method comprising:
associating a first multimedia channel with a first channel number during a first channel navigation period in response to a content of the first multimedia channel at a first time comprising a first content type; and
associating the first multimedia channel with a second channel number that is different than the first channel number during a second channel navigation period that is subsequent to the first channel navigation period in response to the content of the first multimedia channel at a second time comprising a second content type that is different than the first content type.

15. The method of claim 14, further comprising:
providing the content of the first multimedia channel for display in response to a selection of the first channel number during the first channel navigation period.

16. The method of claim 15, further comprising:
providing content of a second multimedia channel for display in response to a selection of the first channel number during the second channel navigation period.

17. The method of claim 15, further comprising:
providing content of the first multimedia channel for display in response to a selection of the second channel number during the second channel navigation period.

18. A computer readable medium embodying a computer program, the computer program comprising:
instructions to generate data representative of an electronic programming guide, the electronic programming guide comprising:
a first channel number sequence associated with a first set of multimedia channels having a first content type at a selected time; and
a second channel number sequence, different than the first number sequence, associated with a second set of multimedia channels having a second content type at the selected time; and
instructions to provide a representation of the electronic programming guide for display.

19. The computer readable medium of claim 18, wherein the computer program further comprises:
instructions to receive user input indicating a selection of a first channel number of the first channel number sequence;
instructions to provide content of a first multimedia channel of the first set of multimedia channels for display when the first channel number sequence includes the first channel number; and
instructions to provide content of a second multimedia channel of the second set of multimedia channels for display when the second channel number sequence includes the first channel number.

20. The computer readable medium of claim 18, wherein the computer program further comprises:
instructions to determine a content type at a first time of each of a plurality of multimedia channels;
instructions to associate one or more multimedia channels of the plurality of multimedia channels with a corresponding channel number of one of the first channel number sequence or the second channel number sequence based on the determined content type of each of the one or more multimedia channels.

21. The computer readable medium of claim 20, wherein the instructions to determine the content type comprise instructions to access content information for the plurality of multimedia channels from an electronic programming guide.

22. The computer readable medium of claim 18, wherein:
the computer program further comprises instructions to provide a search interface responsive to user input indicating a search parameter; and
the electronic programming guide further comprises a third channel number sequence, different than the first and second channel number sequences, associated with a third set of one or more multimedia channels having a characteristic consistent with the search parameter.

23. The computer readable medium of claim 18, wherein:
the electronic programming guide has a multilevel menu hierarchy comprising at least a first level, a second level and a third level; and
the first level includes at least one of a live television category, a recorded television category, a video on demand category, a current rentals category, and an interactive category; an options category and a help category.

24. A multimedia system comprising:
an electronic programming guide module to generate an electronic programming guide having a first channel number sequence and a second channel number sequence, wherein the first channel number sequence is associated with a first set of multimedia channels having a first content type at a selected time and the second channel number sequence is associated with a second set of multimedia channels having a second content type at the selected time.

25. The multimedia system of claim 24, further comprising:
a display interface to provide a representation of the electronic programming guide for display.

26. The multimedia system of claim 25, further comprising:
a user interface to receive user input indicating a selected channel number; and
a channel selector module to provide content of a first multimedia channel of the first set of multimedia channels in response to the first channel number sequence including the selected channel number and to provide content of a second multimedia channel of the second multimedia channels in response to the second channel number sequence including the selected channel number.

27. The multimedia system of claim 24, further comprising:
a channel numbering module to:
determine a content type at the selected time of each a plurality of multimedia channels, wherein the plurality of multimedia channels includes the first and second sets of multimedia channels; and
associate each multimedia channel of at least a subset of the plurality of multimedia channels with one of the first set of multimedia channels or the second set of multimedia channels based on the determined content type at the selected time of the multimedia channel.

28. The multimedia system of claim 24, wherein the multimedia system comprises a set-top box.

29. The multimedia system of claim 24, wherein:
the electronic programming guide has a multilevel menu hierarchy comprising at least a first level, a second level and a third level; and
the first level includes at least one of a live television category, a recorded television category, a video on demand category, a current rentals category, and an interactive category; an options category and a help category.
